(19) United States
(12) Patent Application Publication
(10) Pub. No.: US 2013/0167091 A1
(43) Pub. Date: Jun. 27, 2013

(54) SYSTEMS AND METHODS FOR NAVIGATING IN A HYPER-DIMENSIONAL MEDIA GUIDANCE APPLICATION

(71) Applicants: Walter R. Klappert, Los Angeles, CA (US); Michael R. Nichols, La Canada-Flintridge, CA (US)

(72) Inventors: Walter R. Klappert, Los Angeles, CA (US); Michael R. Nichols, La Canada-Flintridge, CA (US)

(73) Assignee: UNITED VIDEO PROPERTIES, INC., Santa Clara, CA (US)

(21) Appl. No.: 13/333,114

(22) Filed: Dec. 21, 2011

(51) Int. Cl. G06F 3/048

(52) U.S. Cl. 715/849; 715/851

(57) ABSTRACT

Systems and methods for navigating in a hyper-dimensional media guidance application are provided. A first group of content listings is displayed in a first grid corresponding to two grid dimensions (e.g., time versus content source). In response to a user selection of a navigational option, a second group of content listings is displayed in a second grid corresponding to a previous grid dimension and a different grid dimension (e.g., time versus parental rating or genre versus content source). Each grid of content listings may be displayed on a face of an illustrated three-dimensional object that may rotate from displaying one face to displaying another in response to a user navigational option selection. The number of grids displayable to a user is not limited by the physical number of faces on any actual three-dimensional object.

### BACKGROUND OF THE INVENTION

Due to an overwhelming volume of content (e.g., video and audio) available to an average person via, for example, the Internet, cable and satellite television, and radio, interactive media guidance applications, such as interactive program guides, have gained widespread popularity. Typically, interactive media guidance applications present content listings in a grid corresponding to two dimensions, time versus content source (e.g., television channel). The time dimension usually spans a row of the grid, while the content source dimension usually spans a column of the grid. Viewers, however, may wish to search through content listings corresponding to other grid dimensions, such as, for example, genre versus time, parental ratings versus content source, or quality versus genre.

### SUMMARY OF THE INVENTION

In view of the foregoing, systems and methods for navigating in a hyper-dimensional media guidance application are provided. In some embodiments, an interactive media guidance application is provided that may cause a first plurality of content listings to be displayed to a user in a first grid of cells having a row dimension and a column dimension. For example, the first grid may be arranged by row and column dimensions of time and content source, respectively. Receipt of a user selection of a displayed navigational option may cause a second plurality of content listings to be displayed to the user in a second grid of cells having either a different row dimension or a different column dimension than in the first grid of cells, depending upon the selected navigational option. For example, the second grid may be arranged by row and column dimensions of time and parental ratings, respectively, if one navigational option is indicated by the received user selection, or by row and column dimensions of genre and content source, respectively, if another navigational option is indicated by the received user selection.

In some embodiments, the first grid of cells may be displayed to the user on a first face of an illustrated three-dimensional object. Receipt of a user selection of a displayed navigational option may cause the three-dimensional object to be displayed as rotating from displaying the first grid of cells on the first face to displaying the second grid of cells on a second face of the illustrated three-dimensional object. Receipt of each user selection of a displayed navigational option may cause the three-dimensional object to be displayed as rotating from displaying a current grid of cells on a currently displayed face of the object to displaying another grid of cells having a different row or column dimension on another face of the illustrated three-dimensional object.

The number of grids having a different row or column dimension than a previously displayed grid that may be displayed to a user is potentially very large and is not limited in any way by the physical number of faces on an actual three-dimensional object. The number of available content listings grid with different combinations of row and column dimensions may be defined by the media guidance application. The illustrated three-dimensional object therefore may continue to rotate to display new content listings grids on respective new faces of the object as long as directed to by the media guidance application.

In some embodiments, grid cells with content listings displayed therein from a first grid of cells displayed on a first face of an illustrated three-dimensional object may appear to recede into a depth of the illustrated object as the object rotates from displaying the first grid on the first face to displaying a second grid on a second face of the object. This may occur for all content listing cells in the first grid or for only those cells containing content listings that are not going to be displayed in the second grid (e.g., a content listing displayed in a first grid cell that does not correspond to the grid dimensions of the second grid and is thus not going to be displayed in a second grid cell). For example, in a first grid of cells having grid dimensions of time versus parental ratings, a first television program having a parental rating of “TV-14” and start time of “8:00 pm” is listed in a cell of the first grid, which is displayed on a first face of an illustrated three-dimensional object. In response to receipt of a user navigation option, the illustrated object rotates to display a second face having a second grid of cells thereon. The second grid is organized by the grid dimensions of time versus television channel. The first television program, however, is not in the displayed range of television channels in the second grid. The cell containing the first television content listing therefore appears to recede into a depth of the illustrated three-dimensional object as the object rotates to display the second grid on the second face of the object.

In some embodiments, grid cells with content listings displayed therein that are to be included in a second grid of cells displayed on a second face of an illustrated three-dimensional object may appear to emerge from a depth of the illustrated object into the second grid of cells as the illustrated object rotates from displaying a first grid on a first face to displaying the second grid on the second face. This may occur for all content listings cells to be in the second grid of cells or for only those content listing cells that are not in the first grid of cells (i.e., content listing cells newly added to the second grid). For example, a second television program may not be listed in a cell of a first grid having dimensions of time versus parental ratings because that program does not have a parental rating. However, in response to receipt of a user navigation option, causing the illustrated object to rotate to display a second face having a second grid of cells thereon, wherein the second grid is organized by dimensions of time versus television channel, the second television program will appear in a cell thereof because that program is on a channel having a start time that is within the displayed ranges of the time and channel dimensions. The cell containing the second television content listing may therefore appear to emerge from a depth of the illustrated three-dimensional object into the second grid as the object rotates to display the second grid on the second face of the object.

In some embodiments, a user may request a first dimension (e.g., time), a range of the first dimension (e.g., 7:00 pm to 9:00 pm), a second dimension (e.g., ratings), and a range of the second dimension (e.g., “TV-G” to “TV-14”). In response to receiving the user request, the media guidance application may select a plurality of content listings based on the requested dimensions and ranges. The media guidance application may then cause the selected plurality of content listings to be displayed to the user.

### BRIEF DESCRIPTION OF THE DRAWINGS

The above and other advantages of the invention will be apparent upon consideration of the following detailed description, taken in conjunction with the accompanying drawings, in which like reference characters refer to like parts throughout, and in which:

FIG. 1 shows an illustrative display screen that may be used to provide media guidance application listings in accordance with some embodiments of the invention;

FIGS. 2A-C show illustrative display screens that may be used to provide media guidance application listings in accordance with some embodiments of the invention;

FIG. 3 shows another illustrative display screen that may be used to provide media guidance application listings in accordance with some embodiments of the invention;

FIG. 4 illustrates animated features associated with an illustrated three-dimensional object that may be used in media guidance applications in accordance with various embodiments of the invention;

FIGS. 5 and 6 show illustrative display screens that may be used to provide media guidance application listings in accordance with some embodiments of the invention;

FIG. 7 shows another illustrative display screen that may be used to provide media guidance application listings in accordance with some embodiments of the invention;

FIG. 8 shows an illustrative display screen that may be used to provide criteria for displaying media guidance application listings in accordance with some embodiments of the invention;

FIG. 9 shows an illustrative user equipment device in accordance with some embodiments of the invention;

FIG. 10 is a diagram of an illustrative cross-platform interactive media system in accordance with some embodiments of the invention;

FIG. 11 illustrates a flow diagram for navigating a hyper-dimensional media guidance application in accordance with some embodiments of the invention; and

FIG. 12 shows an illustrative XML file for content listing information in accordance with some embodiments of the invention.

### DETAILED DESCRIPTION OF EMBODIMENTS

The invention generally relates to systems and methods for navigating in a hyper-dimensional media guidance application. In particular, systems and methods are provided for presenting to users enhanced graphical user interfaces for viewing content listings in various grid displays having various combinations of grid dimensions.

The amount of content available to users in any given content delivery system can be substantial. Consequently, many users desire a form of media guidance through an interface that allows users to efficiently navigate content selections and easily identify content that they may desire. An application that provides such guidance is referred to herein as an interactive media guidance application or, sometimes, a media guidance application or a guidance application.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content. As referred to herein, the term “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. Various devices and platforms that may implement media guidance applications are described in more detail below.

One of the functions of the media guidance application is to provide media guidance data to users. As referred to herein, the phrase, “media guidance data” or “guidance data” should be understood to mean any data related to content, such as media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), advertisement information (e.g., text, images, media clips, etc.), on-demand information, blogs, social network feeds, websites, and any other type of guidance data that is helpful for a user to navigate among and locate desired content selections.

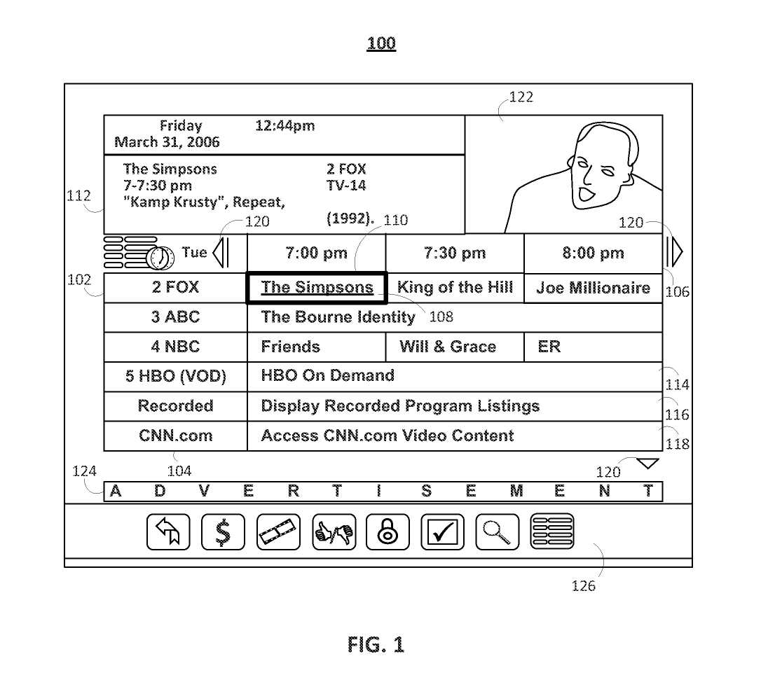

FIGS. 1-3 and 5-7 show illustrative display screens that may be used to provide media guidance data. The display screens shown in FIGS. 1-3 and 5-7 may be implemented on any suitable user equipment device or platform. While the displays of FIGS. 1-3 and 5-7 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria. The organization of the media guidance data is determined by guidance application data. As referred to herein, the phrase, “guidance application data” should be understood to mean data used in operating the guidance application, such as program information, guidance application settings, user preferences, or user profile information.

FIG. 1 shows illustrative grid content listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of content listings, such as content listing 108, where each listing provides the title of the program provided on the listing's associated channel and time. With a user input device, a user can select content listings by moving highlight region 110. Information relating to the content listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L. P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g. FTP).

Grid 102 may provide media guidance data for non-linear programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 102. Advertisement 124 may also be for products or services related or unrelated to the content displayed in grid 102. Advertisement 124 may be selectable and provide further information about content, provide information about a product or a service, enable purchasing of content, a product, or a service, provide content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features. Options region 126 may be part of display 100 (and other display screens described herein), or may be invoked by a user by selecting an on-screen option or pressing a dedicated or assignable button on a user input device. The selectable options within options region 126 may concern features related to content listings in grid 102 or may include options available from a main menu display. Features related to content listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other web sites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 10. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

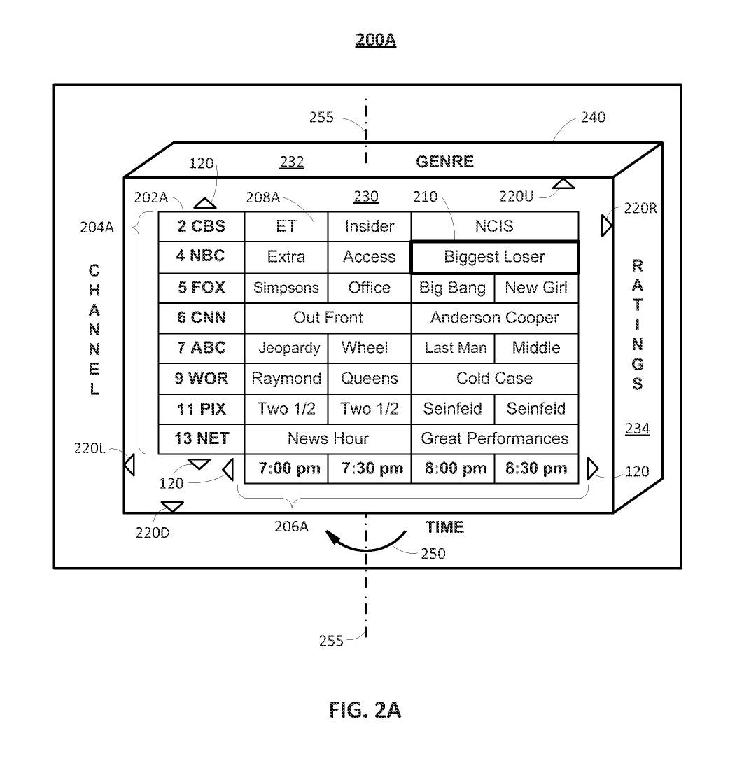

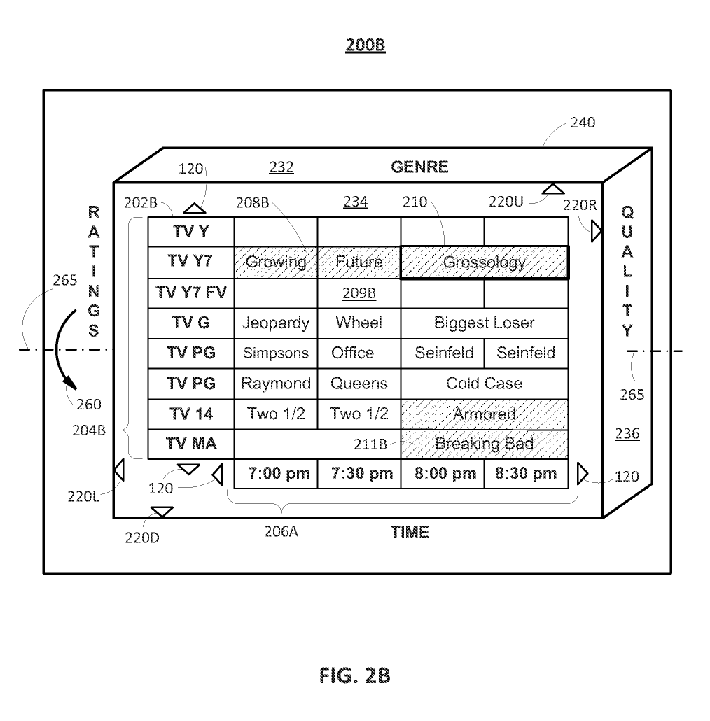

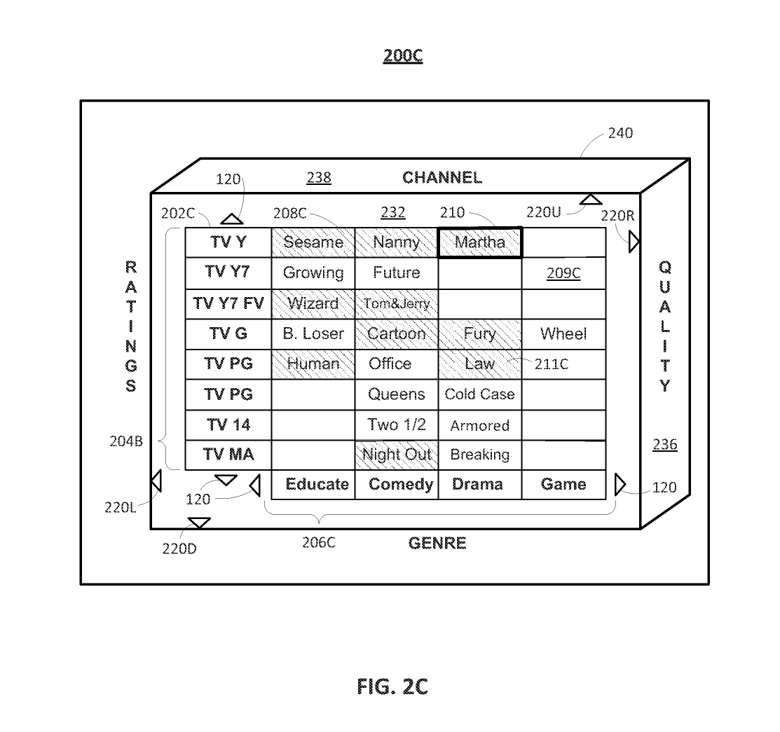

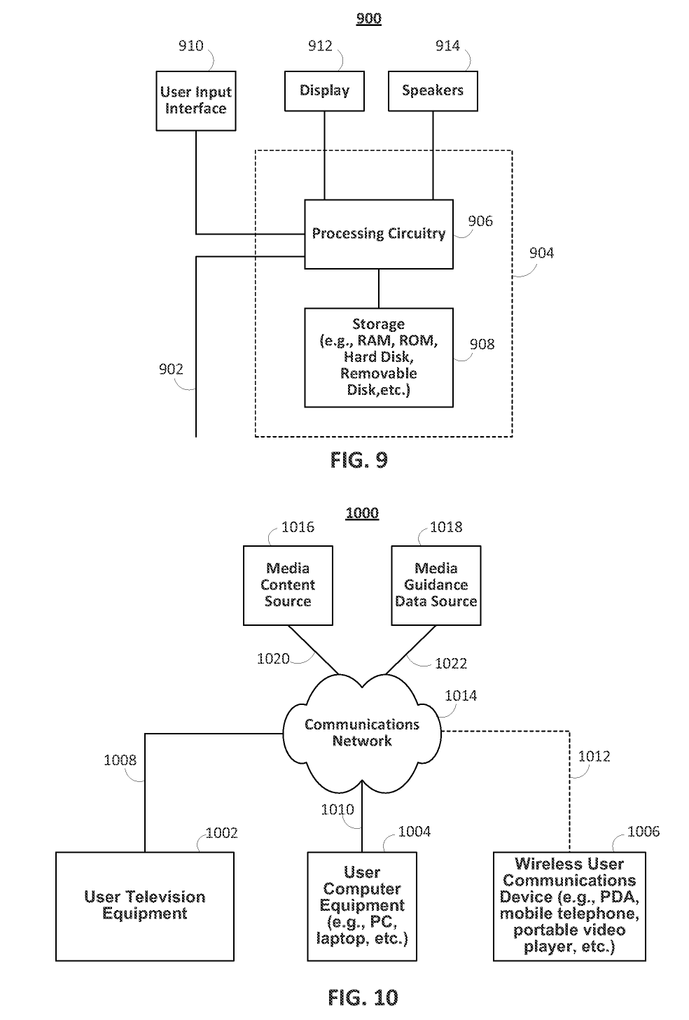

Illustrated grid display 100 may be used in various embodiments of a hyper-dimensional guidance application. For example, in response to receiving a user request to access the hyper-dimensional guidance application, display 100 may be the first, or a default, display presented to the user by control circuitry 904, as described in detail below in connection with FIG. 9. Or, in response to receiving a specific user request to view content listings in a time versus channel/content type grid, display 100 may be displayed to the user by control circuitry 904. In response to receiving a subsequent user request to view content listings in a grid having other than a time dimension or a channel/content type dimension, display 100 may be replaced with another display of content listings by control circuitry 904, as described in more detail below in connection with FIGS. 2A-C and 3-8.

FIG. 2A shows an illustrative content listings display 200A, which includes grid 202A arranged by the dimensions of time and channel/content type. Grid 202A has (1) a column of channel/content type identifiers 204A, where each channel/content type identifier (which is a cell in the column) identifies a different channel or content type available; and (2) a row of time identifiers 206A, where each time identifier (which is a cell in the row) identifies a time block of content. Grid 202A also includes a grid of cells containing content listings, such as content listing 208A, where each listing may provide the title of the content provided on the listing's associated channel and time. As with display 100, a user can select content listings by moving highlight region 210 with user input interface 910, as described in detail below in connection with FIG. 9. Similarly, the ranges of channel/content type identifiers 204A and time identifiers 206A may be changed in response to receiving a user actuation of a desired navigational icon 120 by control circuitry 904.

Grid 202A may be displayed on a front face 230 of an illustrated three-dimensional object 240 by control circuitry 904. The illustrated three-dimensional object may resemble any suitable object. For example, the object may resemble a cube or a rectangular prism. Three-dimensional object 240 may have a top face 232 that may have a grid dimension indicator displayed thereon. Any suitable indicator may be displayed thereon. For example, “genre” may be displayed as the indicator on face 232 in some embodiments. Illustrated three-dimensional object 240 may additionally or alternatively have a right side face 234 that may have a grid dimension indicator displayed thereon. Any suitable indicator may be displayed thereon. For example, “ratings” may be displayed as the indicator on face 234 in some embodiments. Display 200A may additionally or alternatively display a dimension indicator “channel” (for column identifiers 204A) to the left of face 230, and a dimension indicator “time” (for row identifiers 206A) at the bottom of face 230. While faces 232 and 234 are illustrated in FIG. 2A, any suitable number and any suitable locations of faces may be used in some embodiments. In some embodiments, three-dimensional object 240 and/or any other three-dimensional object discussed herein may be a stereoscopic object. In particular, the three-dimensional object may be rendered in two-dimensions but when viewed with a stereoscopic optical device, appears to be a three-dimensional object as shown in the figures. In some embodiments, only a portion of the three-dimensional object may be stereoscopic. For example, the three-dimensional object may be displayed in perspective to give the appearance of a three-dimensional cube but one or more of the media items within the three-dimensional object (e.g., listings 210 and/or faces 232 and 234) may be stereoscopic.

The dimension indicators “genre” and “ratings” and/or any other suitable indicators may be used to indicate that other content listing grids having dimensions other than “time” and “channel” are available for display on other faces of illustrated three-dimensional object 240.

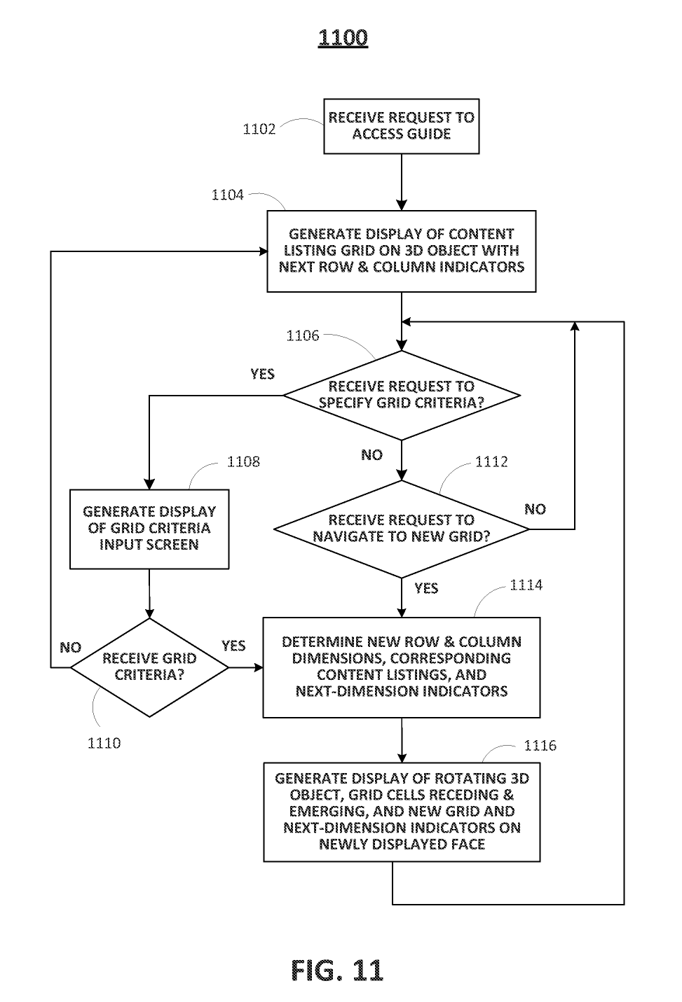

In response to receiving a user actuation of a navigation option, such as, for example, an actuation of one of navigational icons or buttons 220R, 220L, 220U, and 220D, which may be displayed on or near an edge of three-dimensional object 240 (or, additionally or alternatively, in response to receiving the pressing of an arrow key on user input interface 910), three-dimensional object 240 may be rotated in a desired direction by control circuitry 904. For example, if a user would like to see content listings arranged in a grid on face 234, navigational icon 220R may be actuated, and in response to receiving that actuation, control circuitry 904 may present object 240 as rotating horizontally to the left, as indicated by arrow 250, about vertical axis 255 to display face 234 to the user, as shown in FIG. 2B. This may be performed, for example, as described in steps 1112, 1114, and 1116 of process 1100 as described below in connection with FIG. 11.

FIG. 2B shows an illustrative content listings display 200B having a grid 202B arranged by the dimensions of time and parental ratings, instead of time and channel/content type as in grid 202A. Grid 202B may have (1) a new column of parental ratings type identifiers 204B, where each parental ratings type identifier (which is a cell in the column) identifies a different parental rating (e.g., TV-Y (children) through TV-MA (mature audiences); and (2) the same row of time identifiers 206A as in grid 202A, where each time identifier (which is a cell in the row) identifies a time block of programming. Grid 202B may also include cells of content listings, such as content listing 208B, where each listing may provide the title of the content organized by parental rating and time. As described above, a user can select content listings by moving highlight region 210 with a user input interface 910, and control circuitry 904 may change the ranges of the displayed dimension identifiers in response to the user selecting, for example, one of navigational icons 120.

As control circuitry 904 presents three-dimensional object 240 as rotating from displaying grid 202A on face 230 to displaying grid 202B on face 234 in response to receiving a user navigational actuation, content listings from grid 202A that also correspond to identifiers 204B and 206A of grid 202B may be transferred from grid 202A to grid 202B. These listings may appear in new vertical cell positions within the grid based on their parental ratings (instead of their channels). Content listings from grid 202A that do not have parental ratings information may be removed from being listed in grid 202B. Note that some cells in grid 202B may be empty, such as empty cell 209B, because there may not be any content having the parental ratings in the time periods corresponding to those cell positions. For example, as shown in grid 202B, there is no content rated TV-Y or TV-Y7-FV (kids 7 and older with fantasy violence) available from 7:00 pm until 8:30 pm. In some embodiments, empty cells in grid 202B may be filled with additional content listings that may have been outside the range of previously displayed dimension identifiers in grid 202A. For example, content listings 208B and 211B are not listed in grid 202A (FIG. 2A) because they are not available on a channel within the range of channels listed in grid 202A. However, content listings 208B and 211B are shown in a cell of grid 202B because their respective parental rating and time period correspond to the parental rating and time identifiers for their cell positions. Such new listings may be identified in the grid in some way, such as, for example, with a different background color or pattern, such as that shown in the cells containing content listing 208B and 211B. In those embodiments where a row of empty cells occurs, that row may be omitted from the grid or replaced with content corresponding to another ratings type identifier or any other suitable content.

Whenever control circuitry 904 presents three-dimensional object 240 as rotating to display a new content listing grid in response to receiving a user navigational actuation, control circuitry 904 may resize cells of the new grid as needed so content listings displayed therein correspond appropriately to the row and column dimension identifiers. For example, some cells may need to have their width changed, while others may need to have their height changed.

With three-dimensional object 240 positioned such that face 234 is displayed with grid 202B thereon, display 200B may display a dimension indicator “ratings” (for column identifiers 204B) to the left of face 234, and a dimension indicator “time” (for row identifiers 206B) at the bottom of face 234. Three-dimensional object 240 may continue to have top face 232 with a grid dimension indicator of, for example, “genre” displayed thereon, while a new right side face 236 may have a new grid dimension indicator, such as, for example, “quality” displayed thereon. “Quality” may refer to the critical ratings of content which may be expressed in the number of stars a particular program receives from critics and/or viewers. The dimension indicators “genre” and “quality” indicate that other content listing grids with dimensions other than “time” and “ratings” are available for display on other faces of illustrated three-dimensional object 240 in response to receiving user navigational actuations.

If the user would like to see content listings arranged in a grid on top face 232, the user may actuate navigational icon 220U. In response to receiving the user actuation of navigational icon 220U, control circuitry 904 may cause illustrated three-dimensional object 240 to rotate vertically downward, in the direction of arrow 260, about horizontal axis 265 to display face 232 to the user, as shown in FIG. 2C.

FIG. 2C shows an illustrative content listings display 200C having a grid 202C arranged by the dimensions of genre and ratings, instead of time and ratings as in grid 202B. Grid 202C may have (1) the same column of parental ratings type identifiers 204B as in grid 202B, and (2) a new row of genre identifiers 206C, where each genre identifier (which is a cell in the row) identifies a genre, such as, for example, educational, comedy, drama, and game. Grid 202C may include cells of content listings, such as content listing 208C, where each listing may provide the title of content organized by parental rating and genre. As described previously, a user may select content listings by moving highlight region 210 with a user input interface 910, and control circuitry 904 may change the ranges of the dimension identifiers in response to receiving user actuations of navigational icons 120.

As control circuitry 904 presents three-dimensional object 240 as rotating from displaying grid 202B on face 234 to displaying grid 202C on face 232 in response to receiving a user navigational actuation, content listings from grid 202B that also correspond to identifiers 204B and 206C of grid 202C are transferred from grid 202B to grid 202C. These listings may appear in new horizontal cell positions within the grid based on their genre (instead of their time periods). As described previously, control circuitry 904 may resize cells of the new grid as needed so the content listings displayed therein correspond appropriately to the row and column dimension identifiers. Content listings from grid 202B that do not have genre information may be removed from being listed in grid 202C. Also, some empty cells 209C may occur in grid 202C because there may not be any content having the genre and parental ratings corresponding to those cell positions. For example, as shown in grid 202C, there is no content rated TV-Y7 through TV-G available in the “Drama” genre. In some embodiments, control circuitry 904 may fill empty cell positions in grid 202C with additional content listings that may have been outside the range of previously displayed dimension identifiers. For example, content listing 211C is not listed in grid 202B because its time period is outside the range of time identifiers 206A listed in grid 202B. However, content listing 211C is shown in a cell of grid 202C because its parental rating and genre corresponds to the parental rating and genre identifiers for that cell position, and because “time” is not a dimension of grid 202C.

In some embodiments, the range of a previous dimension being replaced by a new dimension in the current grid may be applied to additional content listings that may be used to fill the current grid. That is, additional content listings may also have to correspond with previously displayed dimension ranges so that they may be added to the current grid. Such an option may be used to help users narrow down their choice of content as control circuitry 904 rotates the illustrated three-dimensional object from showing one grid to showing a next grid in response to receiving user navigational actuations.

With three-dimensional object 240 positioned such that face 232 is displayed with grid 202C thereon, display 200C may display the dimension indicator “ratings” (of column identifiers 204B) to the left of face 232, and the dimension indicator “genre” (of row identifiers 206C) at the bottom of face 232. Three-dimensional object 240 may continue to have a right side face 236 with a grid dimension indicator of “quality” displayed thereon. However, three-dimensional object 240 may have a top face 238 with a new grid dimension indicator displayed thereon, such as, for example, “channel.” The “channel” dimension indicator may refer to the same channel dimension that appeared in the column of grid 202A. But in this case, in response to receiving a user actuation of navigational icon 220U, control circuitry 904 may present three-dimensional object 240 as rotating vertically downward, displaying face 238 having a grid thereon with the channel dimension becoming the new row dimension (instead of the column dimension as in grid 202A of display 200A). Any dimension defined in the media guidance application may be available as either a row dimension, a column dimension, or both (but obviously not in the same grid). The ratings dimension may continue to be displayed as the column dimension in the grid on face 238. Similarly, in response to receiving a user actuation of navigational icon 220R, control circuitry 904 may cause three-dimensional object 240 to rotate horizontally to the left, displaying face 236 having a grid thereon with the quality dimension becoming the new column dimension, while the genre dimension continues as the row dimension. Accordingly, control circuitry 904 may fill the cells of the grids displayed on faces 238 and 236 with respective new pluralities of content listings corresponding to the displayed grid dimensions.

Each downward and leftward rotation of illustrated three-dimensional object 240 by control circuitry 904 may offer another new dimension indicator displayed on the top or right side faces of object 240. As illustrated in FIGS. 2A-C, rotation downward about the horizontal axis may cause the column dimension to change, while rotation leftward about the vertical axis may cause the row dimension to change. The number of grid-dimension combinations for organizing content is potentially very large, and may be defined by the media guidance application or another suitable source. The number of displayable grid-dimension combinations is not limited in any way by any physical limitation of an actual three-dimensional object. That is, the number of content listing grids that may be displayed on faces of an illustrated three-dimensional object is not limited by the number of faces on an actual three-dimensional object. The illustrated three-dimensional object of the media guidance application may continue to rotate from one face to another to display as many grids as defined by the media guidance application or another suitable source.

In response to a user having rotated through all of the defined dimensions on either the top or right side faces of illustrated three-dimensional object 240, control circuitry 904 may display again dimension indicators that were previously displayed on the top or right side faces of the object. Control circuitry 904 may repeat previously displayed dimension indicators in a circular or looping fashion. For example, assuming that “channel” is the last new row dimension defined for the grids of illustrated three-dimensional object 240, as shown in display 200C, receipt of a next actuation of navigational icon 220U by control circuitry 904 may cause the “time” dimension to appear in the top face of the next displayed grid, and thus the row dimensions may cycle as follows: time, genre, channel, and back to time. Thereafter, control circuitry 904 may sequentially repeat the display of “genre” and “channel” in the top face as the three-dimensional object rotates vertically downward in response to receiving user navigational actuations. Similarly, assuming that “quality” is the last new column dimension as shown in display 200C, receipt of a next actuation of navigational icon 220R may cause control circuitry 904 to display the “channel” dimension indicator on the right side face of the next displayed grid, and thus the column dimensions may cycle as follows: channel, ratings, quality, and back to channel. Thereafter, displays of “ratings” and “quality” may be sequentially repeated on the right side face as control circuitry 904 may cause the three-dimensional object to rotate horizontally leftward in response to receiving user navigational actuations. Thus, for N different column or row dimensions defined in the media guidance application, the Nth actuation of a same navigational option may cause control circuitry 904 to return to the first of the N dimensions to be displayed.

In some embodiments, actuation of navigational icons 220L and 220D may cause control circuitry 904 to cause a previously displayed grid to reappear. For example, in response to actuating navigational icon 220D while viewing display 200C (of FIG. 2C), control circuitry 904 may present three-dimensional object 240 as rotating from displaying grid 202C on face 232 to displaying previous grid 202B on face 234 (of FIG. 2B). In response to actuating navigational icon 220L, control circuitry 904 may present three-dimensional object 240 as rotating from displaying grid 202B on face 234 (of FIG. 2B) to displaying previous grid 202A on face 230 (of FIG. 2A). Receipt of an equal number of opposite navigational actuations, such as, for example, receipt of N actuations of icon 220D and N actuations of icon 220U, may cause control circuitry 904 to display again an initially displayed dimension associated with those navigational actuations (e.g., the row dimension is associated with icons 220D and 220U). In other embodiments, such as those with a small number of different dimension combinations, the options of rotating the three-dimensional object to display either the bottom or left side faces may not be available (i.e., navigational icons 220L and 220D may not be displayed).

As mentioned above, in some embodiments, the bottom and left side faces of a three-dimensional object may additionally or alternatively be used to indicate the next available grid dimensions. In these embodiments, navigational icons 220L and 220D may be displayed. Receipt of a user actuation of icon 220L may cause control circuitry 904 to present the illustrated three-dimensional object as rotating horizontally to the right to display the left side face, while receipt of a user actuation of icon 220D may cause control circuitry 904 to present the illustrated three-dimensional object to rotate vertically upward to display the bottom side face.

Note that arrow-shaped navigational icons 220R, 220L, 220U, and 220D may function in a manner opposite to that described above. That is, instead of control circuitry 904 causing the illustrated three-dimensional object to rotate in a direction opposite to that pointed to by the actuated icon, which points in the direction of the face to be displayed in response to actuation, an actuated icon may cause control circuitry 904 to present the illustrated three-dimensional object to rotate in the same direction as pointed to by the actuated icon, thus causing the face on the opposite side of the icon to be displayed next.

In some embodiments of the invention, the displayed illustrated three-dimensional object may have only one alternating rotation option available at any one time and, accordingly, may show only one additional face in addition to the front face, with the additional face having a next-dimension indicator displayed thereon. For example, a first grid display may show an illustrated three-dimensional object with a front face and a top face, wherein only the top face indicates the availability of another content listing grid having a different row indicator. The first grid display may also include only a single navigational icon, such as navigational icon 220U. In response to actuating that icon, control circuitry 904 may present a second grid display showing the illustrated three-dimensional object with a front face and a right side face, wherein the right side face indicates the availability of another content listing grid having a different column indicator. The second grid display may also include only a single navigational icon, such as navigational icon 220R. Receipt of each actuation of the displayed navigational icon may cause control circuitry 904 to alternate the display of the top and right side faces with next-dimension indicators displayed thereon.

The content listings that may be displayed in grids of the invention may include, for example, television content listings, book listings, music listings, movie listings, video-on-demand listings, still image listings, game listings, video recording listings, or audio recording listings.

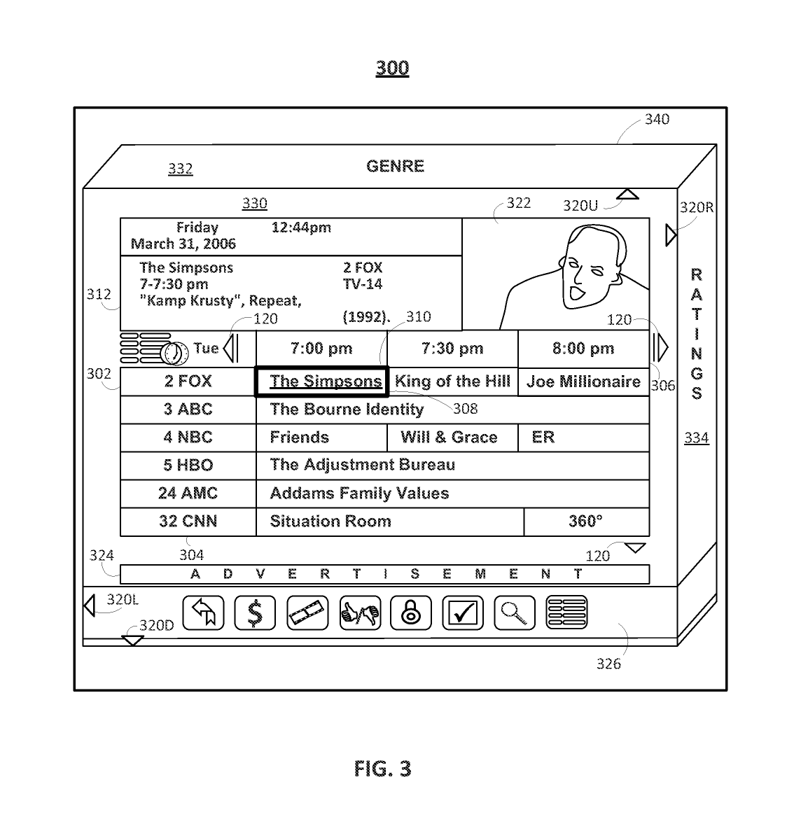

FIG. 3 shows an illustrative content listings display 300 that may be used in a hyper-dimensional guidance application. Display 300 may include a content listing display similar to display 100 presented on a front face 330 of an illustrated three-dimensional object 340. Display 300 may include a grid 302 with (1) a column of channel identifiers 304, where each channel identifier (which is a cell in the column) identifies a different channel available, and (2) a row of time identifiers 306, where each time identifier (which is a cell in the row) identifies a time block of programming. Grid 302 may also include cells of content listings, such as content listing 308, where each listing may provide the title of the content provided on the listing's associated channel and time. A user may select content listings by moving highlight region 310 with a user input interface 910. In response to receiving a user actuation of a desired navigational icon 120, control circuitry 904 may change the displayed ranges of channel identifiers 304 and time identifiers 306. Display 300 may also include any one or more of a program information region 312, video region 322, advertisement region 324, and options region 326, each having a functionality that may be similar or identical to regions 112, 122, 124, and 126, respectively, of display 100.

Three-dimensional object 340 may have a top face 332 that may have a grid dimension indicator of “genre” or, alternatively, any other suitable indicator displayed thereon, and may also have a right side face 334 that may have a grid dimension indicator of “ratings” or, alternatively, any other suitable indicator displayed thereon. Navigational icons 320R, 320L, 320U, and 320D may be displayed on or near an edge of three-dimensional object 340 (in other embodiments, only navigational icons 320U and 320R may be displayed). In response to a user selection of navigational icon 320U or 320R, control circuitry 904 may cause illustrated three-dimensional object 340 to rotate to display either top face 332 or right side face 334. Once in the front of object 340, face 332 or 334 may have another grid displayed thereon that may include cells of content listings corresponding to the row and column dimensions displayed thereon. When faces 332 and/or 334 are in the front of object 340, top and/or right side faces displaying another next-dimension indicator thereon may be presented by control circuitry 904. The functionality provided by control circuitry 904 of illustrated three-dimensional object 340 may be similar or identical to that described above with respect to illustrated three-dimensional object 240 and its associated grids, grid dimensions, and alternative embodiments. For example, additional grids of content listings corresponding to additional combinations of grid dimensions may be provided by control circuitry 904 in response to receiving actuations of navigational icons 320U and/or 320R.

Note that the invention is not in any way limited to the dimensions, dimension ranges, and dimension indicators described above. Dimensions may alternatively or additionally include, for example, an alphabetized list of actors, authors, musicians, books, movies, music, video games, sporting activities, vacations, etc. In view of the vast amounts of content available from sources via the Internet (e.g., online video recordings), on-demand content providers, and even a user's own recordings and saved content, most of which have no “time-of-day” associated with them, dimensions may be anything suitable under which content may be categorized and/or organized.

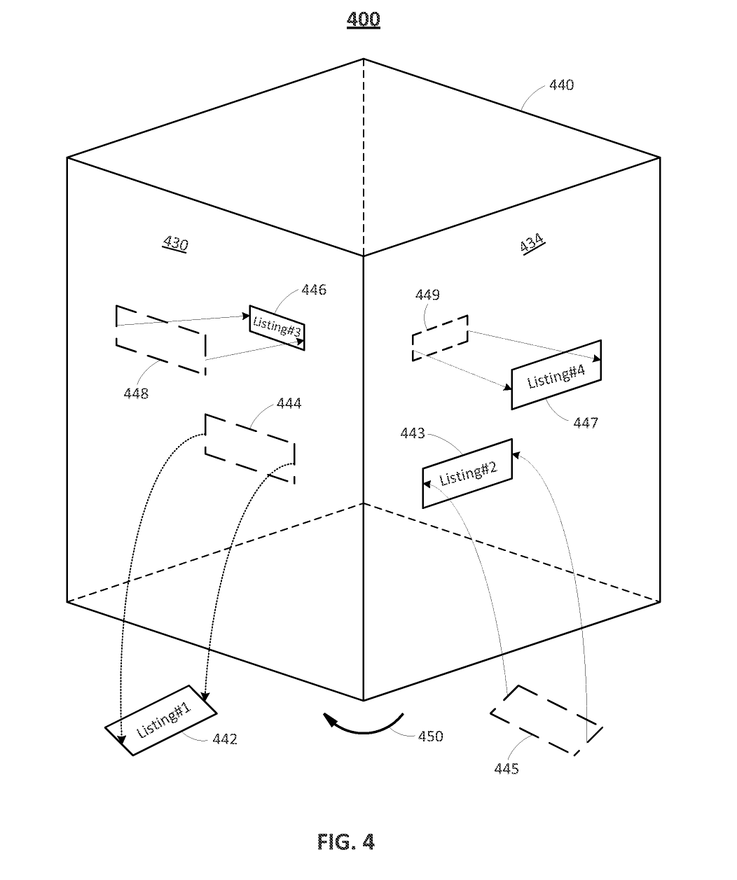

FIG. 4 illustrates various animation features that may be used in the hyper-dimensional media guidance application in accordance with some embodiments of the invention. As described above, content listings displayed in various grid cells may change as control circuitry 904 presents the illustrated three-dimensional object as rotating from displaying a first grid of cells on one face of the object to displaying a second grid of cells on another face of the object. Some content listings may change cell positions, while other content listings that appear in the first grid may not appear in the second grid, while still other content listings that appear in the second grid may not appear in the first grid.

In some embodiments, content listings that appear in a first grid, but do not appear in a second grid, may be animated by control circuitry 904 to appear as if the cells containing those content listings are falling off of or flying away from the first grid as the three-dimensional object rotates. For example, in FIG. 4, three-dimensional object 440 is illustrated as rotating horizontally to the left (as indicated by arrow 450). Content listing cell 442, which contains LISTING#1, is illustrated in FIG. 4 as having appeared in cell position 444 in a content listing grid on face 430 of object 440. (Note that the grid, its features, and features of three-dimensional objects as described above in connection with FIGS. 2A-C and 3 are not shown to avoid overcomplicating the drawing.) As control circuitry 904 presents object 440 as rotating, content listing cell 442 may be displayed as falling out of the grid and off of face 430.

In some embodiments, content listings that appear in a second grid, but do not appear in a first grid, may be animated by control circuitry 904 to appear as if the cells containing those content listings are flying or moving into the second grid from outside the illustrated three-dimensional object as the object rotates. For example, as illustrated in FIG. 4, content listing cell 443, which contains LISTING#2, is shown in its designated cell position in the grid on face 434. As control circuitry 904 presents object 440 as rotating, content listing cell 443 may be displayed as flying or moving into that cell position from a position 445, which is outside of object 440, as object 440 rotates.

In some embodiments, control circuitry 904 may animate one, some, or all cells from a first grid on a first face to appear as if the cells are receding into a depth of the illustrated three-dimensional object as the object rotates from displaying the first face to displaying a second face. For example, as shown in FIG. 4, content listing cell 446, which contains LISTING#3, is illustrated as having receded into a depth of three-dimensional object 440 from cell position 448 of a content listing grid on face 430 of object 440 as object 440 rotates from displaying face 430 to displaying face 434. Alternatively, only some cells from a first grid may be animated by control circuitry 904 to appear as if receding into a depth of the illustrated three-dimensional object, such as those that are to appear in a grid on face 434, while other cells may be animated by control circuitry 904 to appear as if falling off of or flying away from the grid on face 430, as described above.

In some embodiments, one, some, or all cells of a second grid on a second face of an illustrated three-dimensional object may be animated by control circuitry 904 to appear as if the cells are emerging from a depth of the three-dimensional object as the object rotates to present the second face. For example, as illustrated in FIG. 4, content listing cell 447, which contains LISTING#4, is in its designated grid cell position on face 434 after having emerged from position 449 in a depth of three-dimensional object 440 as object 440 rotates to present face 434.

In some embodiments, control circuitry 904 may combine the receding and emerging animation effects. For example, cells from a first grid on a first face of an illustrated three-dimensional object may recede into a depth of the object as the object rotates from displaying the first face to displaying a second face. At about the midpoint in the rotation, as shown by the position of three-dimensional object 440 in FIG. 4, those first grid cells containing content listings that are to appear in a second grid on the second face may reverse direction and start emerging from within the three-dimensional object to fill in the cell positions in the second grid as the three-dimensional object completes its rotation to display the second face. Grid cells containing content listings from the first grid that are not be displayed in the second grid may appear to disappear into the depth of the three-dimensional object as the object reaches the midway point in the rotation. Similarly, grid cells containing content listings for the second grid that are not displayed in the first grid may appear in the depth of the three-dimensional object as the object reaches the midway point in the rotation and may then begin to emerge as the object continues rotating to display the second face.

In some embodiments, control circuitry 904 may additionally or alternatively combine any combination of one or more of the receding, emerging, falling off, and flying into animation effects described above. In some embodiments, control circuitry 904 may display a special visual effect as the three-dimensional object rotates from displaying one face to another to indicate the direction of rotation or change in direction.

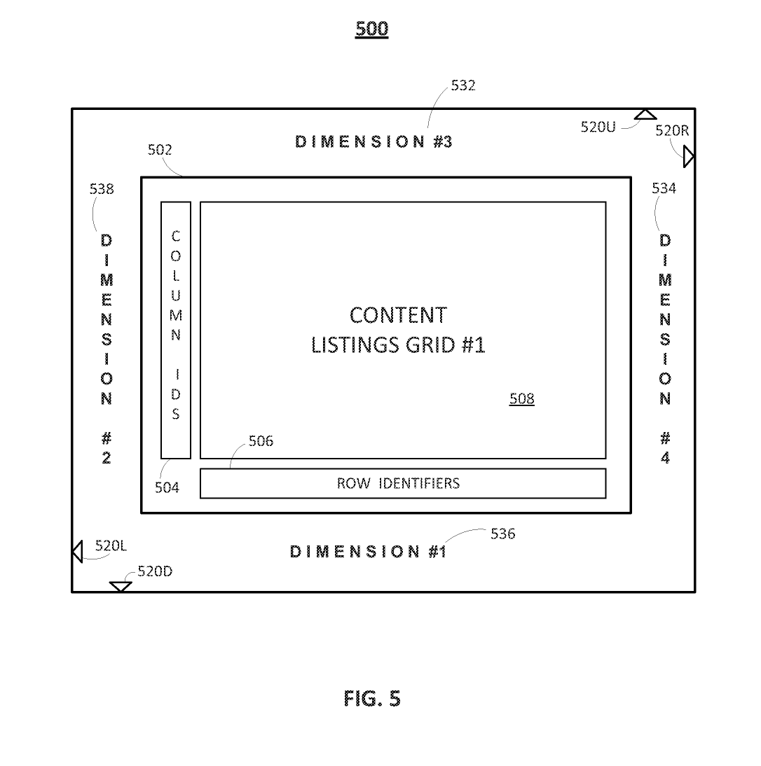

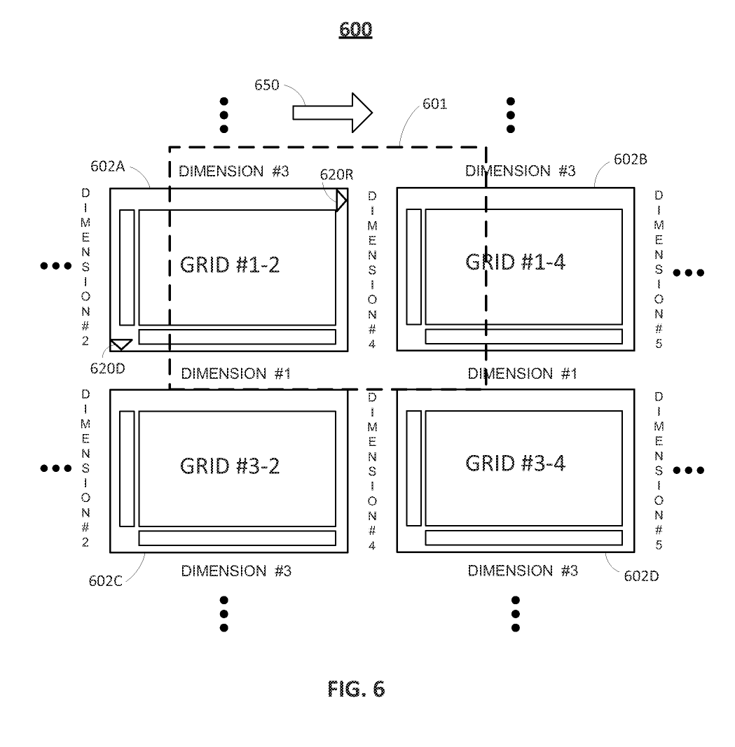

FIGS. 5 and 6 show another display arrangement for providing content listings in a hyper-dimensional media guidance application in accordance with some embodiments of the invention. Content listings display 500 may include a content listings grid 502, which has column identifiers 504, row identifiers 506, and a grid of content listing cells 508. Grid 502 may be, for example, any one of grids 102, 202A-C, or 302 of FIGS. 1-3, or any other suitable grid. Display 500 may also include dimension indicators 532, 534, 536, and 538 arranged on the top, right side, bottom, and left side, respectively, of grid 502. The dimension indicators may be, for example, any of those described above such as time, content source, genre, ratings, and quality, to name just a few, or any other suitable dimension indicators. As displayed in FIG. 5, the row identifiers of grid 502 may be of DIMENSION #1 and the column identifiers may be of DIMENSION #2. Dimension indicators 532 and 534 may indicate that other grids displaying other pluralities of content listings corresponding to other row and column dimensions are available. Display 500 may also include navigational icons 520U, 520R, 520L, 520D. In response to receipt of a user navigational actuation, control circuitry 904 may cause a new grid of content listing cells to be displayed. For example, if a user actuates navigational icon 520U, control circuitry 904 may respond by displaying a grid of content listing cells corresponding to row identifiers of DIMENSION #3 and column identifiers of DIMENSION #2. If the user actuates navigational icon 520R, control circuitry 904 may respond by displaying a grid of content listing cells corresponding to row identifiers of DIMENSION #1 and column identifiers of DIMENSION #4. The guidance application of FIG. 5 may function similarly or identically to that of FIGS. 2A-C except for the display and rotation of the three-dimensional object.

In some embodiments, the transition from a first content listing grid to a second content listing grid may be displayed to a user by control circuitry 904 as illustrated in FIG. 6. FIG. 6 shows four representative content listing grids 602A-D, arranged in a 2×2 configuration, which is conceptual to aid in the understanding of this embodiment. Each one of grids 602A-D is available for display to a user by control circuitry 904. Each pair of grids shares a dimension. For example, grids 602A and 602B share DIMENSION #4, while grids 602A and 602C share DIMENSION #1. Note that while only four grids are shown, the number of grids having different combinations of two grid dimensions defined in the guidance application may be substantial. Thus, the conceptual grid arrangement shown in FIG. 6 may be expanded in any one or more directions (i.e., up, down, left, and/or right) to include all the defined grids. When the last defined grid has been reached in any one direction, the next dimension indicator in that direction may wrap around to the first displayed dimension indicator. For example, grids 602A and 602B show dimension indicator DIMENSION #3 at the top of their grids, while grids 602C and 602D show dimension indicator DIMENSION #3 at the bottom of their grids. This indicates that in response to receiving the next downward navigational actuation while either grid 602C or 602D is displayed, control circuitry 904 may present either grid 602A or 602B, respectively, for display, thus conceptually wrapping back around the 2×2 configuration.

The transition from a first content listing grid to a second content listing grid may be displayed to a user by control circuitry 904 as illustrated in FIG. 6. In response to receiving a user navigational actuation of icon 620R, indicating that the user would like to see grid 602B, control circuitry 904 may cause grid 602A to appear to move left, scrolling out of display screen 601, while grid 602B may appear to scroll into display screen 601. This can be thought of as display screen 601 moving to the right (in the direction of arrow 650) from displaying grid 602A to displaying grid 602B. In response to receiving a user navigational actuation of icon 620D, indicating the user would like to see grid 602C, control circuitry 904 may cause grid 602A to appear to scroll up and out of the display screen, while grid 602C may appear to scroll up and into the display screen.

The content listing displays of FIGS. 5 and 6 may require less graphics and less processing power than embodiments displaying content listings grids on faces of illustrated three-dimensional objects that rotate in response to user navigational selections. Media guidance applications incorporating the displays of FIGS. 5 and 6 may therefore be able to be implemented on devices with less processing power and capability than those that can implement guidance applications incorporating the rotating three-dimensional objects.

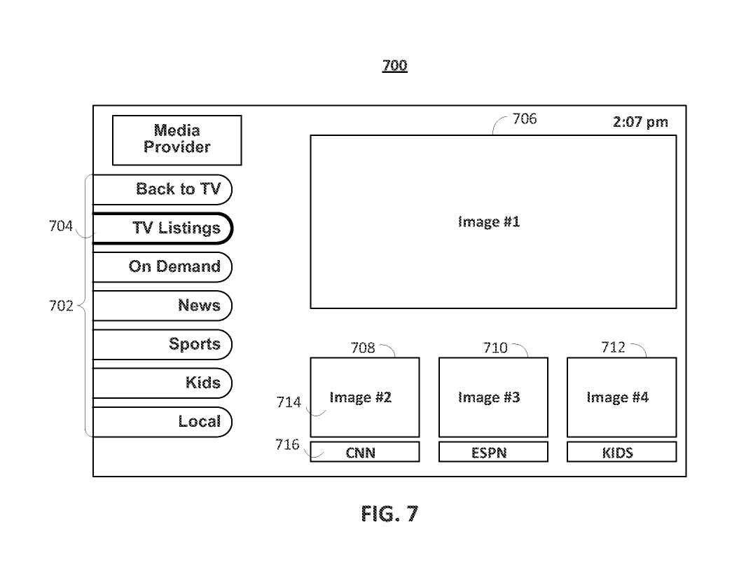

Another display arrangement for providing media guidance is shown in FIG. 7. Video mosaic display 700 includes selectable options 702 for content information organized based on content type, genre, and/or other organization criteria. In display 700, television listings option 704 is selected, thus providing listings 706, 708, 710, and 712 as broadcast program listings. In display 700, the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 708 may include more than one portion, including media portion 714 and text portion 716. Media portion 714 and/or text portion 716 may be selectable to view content in full-screen or to view information related to the content displayed in media portion 714 (e.g., to view listings for the channel that the video is displayed on).

The listings in display 700 are of different sizes (i.e., listing 706 is larger than listings 708, 710, and 712), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Dec. 29, 2005, which is hereby incorporated by reference herein in its entirety.

Display 700 may be used in various embodiments of a hyper-dimensional guidance application. For example, in response to receiving a user request to access the hyper-dimensional guidance application, control circuitry 904 may cause display 700 to be the first, or a default, display presented to a user on the face of an illustrated three-dimensional object. Or, in response to receiving a specific user request to view content listings arranged as shown in display 700, control circuitry 904 may cause display 700 to be displayed to the user on a face of an illustrated three-dimensional object as the object rotates to present that face with display 700 thereon. In some embodiments, for example, in response to a user selection of one of selectable options 702, control circuitry 904 may present the three-dimensional object as rotating to display another face with listings 706, 708, 710, and 712 corresponding to the selected option 702.

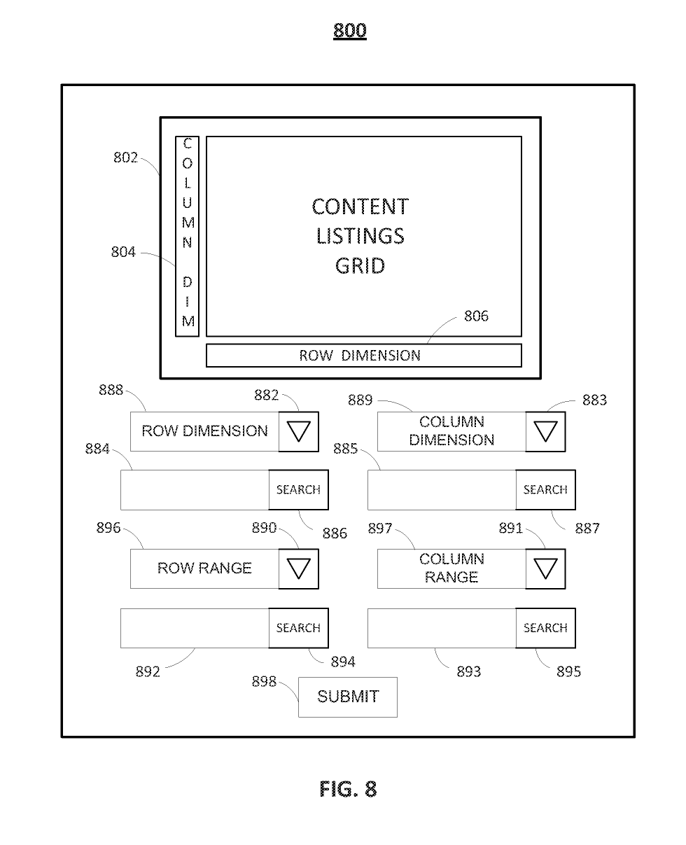

FIG. 8 shows a representative display 800 that a user may use to submit a request to control circuitry 904 for a content listing grid display having user selected row and column dimensions and/or user selected row and column ranges (to be used as the row and column identifiers discussed above). To access display 800, a user may submit a request by selecting a selectable option provided in a display screen (e.g., a menu option, a listings option, an icon, a hyperlink, etc.) or by pressing a dedicated button (e.g., a GRID CRITERIA button) on a remote control or other user input interface or device, such as user input interface 910. Display 800 may include a representation of a content listings grid 802 for reference by a user. To select a row dimension, the user may actuate drop down menu button 882. In response, a selectable list of available row dimensions may be displayed. The user may select a desired row dimension by, for example, highlighting the desired dimension and then actuating a key using, for example, user input interface 910. A row dimension may additionally or alternatively be selected by making any entry in search field 884 and actuating search button 886, wherein control circuitry 904 may present a selectable list of one or more dimensions meeting the user's search criteria. In response to selecting a row dimension, control circuitry 904 may cause the selected row dimension to appear in row dimension indicator 888. Similarly, to select a range for the row dimension, the user may actuate drop down menu button 890. In response, control circuitry 904 may display a selectable list of ranges for the selected row dimension. For example, if the selected row dimension is time, a list of two hour time periods starting at 12:00 am may be displayed by control circuitry 904. Alternatively, the user may make an entry in search field 892 and actuate search button 894, wherein control circuitry 904 may present a selectable list of one or more dimension ranges meeting the entered search criteria. For example, in response to a user entering “1:30” in search field 892, control circuitry 904 may present two time periods to the user, “1:00-3:00 am” and “1:00-3:00 pm.” In response to selecting a range for the row dimension, control circuitry 904 may cause the selected range to appear in range indicator 892. A user may select a column dimension and a range for the selected column dimension by similarly using drop down menu button 883 or entering search criteria in search field 885 and actuating search button 887. Control circuitry 904 may cause a selected column dimension to appear in column dimension indicator 889. To select a range for the column dimension, the user may actuate drop down menu button 891 or enter search criteria in search field 893 and actuate search button 895, as discussed above for selecting a range for the row dimension. In response to selecting a range for the column dimension, control circuitry 904 may cause the selected range to appear in range indicator 893. Note that control circuitry 904 alternatively or additionally may cause the selected dimensions and ranges to be displayed in grid 802 in areas 804 and 806. After the desired row and column dimensions and ranges have been selected, the user may actuate submit button 898 to submit the grid criteria to control circuitry 904. Note that selecting a range for a selected dimension may not be required. For example, control circuitry 904 may display a content listing grid with the requested row and/or column dimension and a default range of row and/or column identifiers.

Users may access content and the media guidance application (and its display screens described above and below) from one or more of their user equipment devices. FIG. 9 shows a generalized embodiment of illustrative user equipment device 900.

More specific implementations of user equipment devices are discussed below in connection with FIG. 10. User equipment device 900 may receive content and data via input/output (hereinafter “I/O”) path 902. I/O path 902 may provide content (e.g., broadcast programming, on-demand programming, Internet content, content available over a local area network (LAN) or wide area network (WAN), and/or other content) and data to control circuitry 904, which includes processing circuitry 906 and storage 908. Control circuitry 904 may be used to send and receive commands, requests, and other suitable data using I/O path 902. I/O path 902 may connect control circuitry 904 (and specifically processing circuitry 906) to one or more communications paths (described below). I/O functions may be provided by one or more of these communications paths, but are shown as a single path in FIG. 9 to avoid overcomplicating the drawing.

Control circuitry 904 may be based on any suitable processing circuitry such as processing circuitry 906. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 904 executes instructions for a media guidance application stored in memory (i.e., storage 908).

In client-server based embodiments, control circuitry 904 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 908 that is part of control circuitry 904. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 908 may be used to store various types of content described herein as well as media guidance information, described above, and guidance application data, described above. For example, one or more representations of three-dimensional objects for displaying content listing grids thereon, associated animation files, and/or any other suitable image for presenting content listing grids on three-dimensional objects may be stored in storage 908. Nonvolatile memory may also be used (e.g., to launch a boot-up routine and other instructions). Cloud-based storage, described in relation to FIG. 10, may be used to supplement storage 908 or instead of storage 908.

Control circuitry 904 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 904 may also include scaler circuitry for upconverting and downconverting content into the preferred output format of the user equipment 900. Circuitry 904 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 908 is provided as a separate device from user equipment 900, the tuning and encoding circuitry (including multiple tuners) may be associated with storage 908.

A user may send instructions to control circuitry 904 using user input interface 910. User input interface 910 may be any suitable user interface, such as a remote control, mouse, trackball, keypad, keyboard, touch screen, gesture recognition, touchpad, stylus input, joystick, voice recognition interface, or other user input interfaces. In connection with FIGS. 2A-C, 3, and 5-7, user input interface 910 may be used to select one of the displayed navigational icons. For example, a user may use arrow keys on a remote control device to scroll from one navigational icon to another until a desired icon is highlighted, indicated via a cursor, or identified in some other manner. The user may then press an enter key on the remote control device to transmit the user selection to control circuitry 904. In response to receiving the user selection, control circuitry 904 may cause to be presented a rotating animation of the displayed three-dimensional object in the direction indicated by the navigational icon selection.

Display 912 may be provided as a stand-alone device or integrated with other elements of user equipment device 900. Display 912 may be one or more of a monitor, a television, a liquid crystal display (LCD) for a mobile device, or any other suitable equipment for displaying visual images. In some embodiments, display 912 may be HDTV-capable. In some embodiments, display 912 may be a 3D display, and the interactive media guidance application and any suitable content may be displayed in 3D. A video card or graphics card may generate the output to the display 912. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 904. The video card may be integrated with the control circuitry 904. Speakers 914 may be provided as integrated with other elements of user equipment device 900 or may be stand-alone units. The audio component of videos and other content displayed on display 912 may be played through speakers 914. In some embodiments, the audio may be distributed to a receiver (not shown), which processes and outputs the audio via speakers 914.

In some embodiments, control circuitry 904 may be configured to receive instructions from user input interface 910. For example, control circuitry 904 may cause media guidance application listings to be presented by selecting a selectable option in a display screen (e.g., a listings option) or pressing a dedicated button (e.g., a GUIDE button) on a remote control or other user input interface 910.

In some embodiments, control circuitry 904 may be configured to receive an instruction from user input interface 910 to display another content listings grid on the face of an illustrated three-dimensional object. In response to receiving the instruction, control circuitry 904 may determine which media assets are to be listed in cells of the grid and retrieve those content listings. For example, control circuitry 904 may determine which media assets are currently being presented in a guidance display grid and, based on the determination, retrieve additional content listings corresponding to the row and column dimensions of the new grid from a database, media content source 1016, media guidance data source 1018, or any other suitable source.

Control circuitry 904 may cause the retrieved content listings to be presented in cells of a guidance grid display. For example, control circuitry 904 may retrieve a plurality of content listings that correspond to a row dimension of time and a column dimension of parental ratings.

In some embodiments, control circuitry 904 may receive an indication that the user has selected one of the navigational icons. In response to receiving the indication, control circuitry 904 may animate a rotation of the three-dimensional object. For example, control circuitry 904 may provide a horizontally or vertically animated rotation of the three-dimensional object as illustrated in FIGS. 2A-C. In another example, in response to receiving the indication, control circuitry 904 may provide an animation of one content listing grid scrolling off the screen while another content listing grid scrolls onto the screen, as illustrated in FIG. 6.

The guidance application may be implemented using any suitable architecture. For example, it may be a stand-alone application wholly implemented on user equipment device 900. In such an approach, instructions of the application are stored locally, and data for use by the application is downloaded on a periodic basis (e.g., from an out-of-band feed, from an Internet resource, or using another suitable approach). In some embodiments, the media guidance application is a client-server based application. Data for use by a thick or thin client implemented on user equipment device 900 is retrieved on-demand by issuing requests to a server remote to the user equipment device 900. In one example of a client-server based guidance application, control circuitry 904 runs a web browser that interprets web pages provided by a remote server.

In some embodiments, the media guidance application is downloaded and interpreted or otherwise run by an interpreter or virtual machine (run by control circuitry 904). In some embodiments, the guidance application may be encoded in the ETV Binary Interchange Format (EBIF), received by control circuitry 904 as part of a suitable feed, and interpreted by a user agent running on control circuitry 904. For example, the guidance application may be an EBIF application. In some embodiments, the guidance application may be defined by a series of JAVA-based files that are received and run by a local virtual machine or other suitable middleware executed by control circuitry 904. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 900 of FIG. 9 can be implemented in system 1000 of FIG. 10 as user television equipment 1002, user computer equipment 1004, wireless user communications device 1006, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 9 may not be classified solely as user television equipment 1002, user computer equipment 1004, or a wireless user communications device 1006. For example, user television equipment 1002 may, like some user computer equipment 1004, be Internet-enabled allowing for access to Internet content, while user computer equipment 1004 may, like some television equipment 1002, include a tuner allowing for access to television programming. The media guidance application may have the same layout on various different types of user equipment or may be tailored to the display capabilities of the user equipment. For example, on user computer equipment 1004, the guidance application may be provided as a web site accessed by a web browser. In another example, the guidance application may be scaled down for wireless user communications devices 1006.

In system 1000, there is typically more than one of each type of user equipment device but only one of each is shown in FIG. 10 to avoid overcomplicating the drawing. In addition, each user may utilize more than one type of user equipment device and also more than one of each type of user equipment device.

In some embodiments, a user equipment device (e.g., user television equipment 1002, user computer equipment 1004, wireless user communications device 1006) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 1014. Namely, user television equipment 1002, user computer equipment 1004, and wireless user communications device 1006 are coupled to communications network 1014 via communications paths 1008, 1010, and 1012, respectively. Communications network 1014 may be one or more networks including the Internet, a mobile phone network, mobile voice or data network (e.g., a 4 G or LTE network), cable network, public switched telephone network, or other types of communications network or combinations of communications networks. Paths 1008, 1010, and 1012 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 1012 is drawn with dotted lines to indicate that in the exemplary embodiment shown in FIG. 4 it is a wireless path and paths 1008 and 1010 are drawn as solid lines to indicate they are wired paths (although these paths may be wireless paths, if desired). Communications with the user equipment devices may be provided by one or more of these communications paths, but are shown as a single path in FIG. 10 to avoid overcomplicating the drawing.

Although communications paths are not drawn between user equipment devices, these devices may communicate directly with each other via communication paths, such as those described above in connection with paths 1008, 1010, and 1012, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 1014.

System 1000 includes content source 1016 and media guidance data source 1018 coupled to communications network 1014 via communication paths 1020 and 1022, respectively. Paths 1020 and 1022 may include any of the communication paths described above in connection with paths 1008, 1010, and 1012. Communications with the content source 1016 and media guidance data source 1018 may be exchanged over one or more communications paths, but are shown as a single path in FIG. 10 to avoid overcomplicating the drawing. In addition, there may be more than one of each of content source 1016 and media guidance data source 1018, but only one of each is shown in FIG. 10 to avoid overcomplicating the drawing. (The different types of each of these sources are discussed below.) If desired, content source 1016 and media guidance data source 1018 may be integrated as one source device. Although communications between sources 1016 and 1018 with user equipment devices 1002, 1004, and 1006 are shown as through communications network 1014, in some embodiments, sources 1016 and 1018 may communicate directly with user equipment devices 1002, 1004, and 1006 via communication paths (not shown) such as those described above in connection with paths 1008, 1010, and 1012.

Content source 1016 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the ABC, INC., and HBO is a trademark owned by the Home Box Office, Inc. Content source 1016 may be the originator of content (e.g., a television broadcaster, a Webcast provider, etc.) or may not be the originator of content (e.g., an on-demand content provider, an Internet provider of content of broadcast programs for downloading, etc.). Content source 1016 may include cable sources, satellite providers, on-demand providers, Internet providers, over-the-top content providers, or other providers of content. Content source 1016 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 1018 may provide media guidance data, such as the media guidance data described above. Media guidance application data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 1018 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 1018 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 1018 may provide user equipment devices 1002, 1004, and 1006 the media guidance application itself or software updates for the media guidance application.

Media guidance applications may be, for example, stand-alone applications implemented on user equipment devices. For example, the media guidance application may be implemented as software or a set of executable instructions which may be stored in storage 908, and executed by control circuitry 904 of a user equipment device 900. In some embodiments, media guidance applications may be client-server applications where only a client application resides on the user equipment device, and a server application resides on a remote server. For example, media guidance applications may be implemented partially as a client application on control circuitry 904 of user equipment device 300 and partially on a remote server as a server application (e.g., media guidance data source 1018) running on control circuitry of the remote server. When executed by control circuitry of the remote server (such as media guidance data source 1018), the media guidance application may instruct the control circuitry to generate the guidance application displays and transmit the generated displays to the user equipment devices. The server application may instruct the control circuitry of the media guidance data source 1018 to transmit data for storage on the user equipment. The client application may instruct control circuitry of the receiving user equipment to generate the guidance application displays.

Content and/or media guidance data delivered to user equipment devices 1002, 1004, and 1006 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 1000 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 10.

In one approach, user equipment devices may communicate with each other within a home network. User equipment devices can communicate with each other directly via short-range point-to-point communication schemes describe above, via indirect paths through a hub or other similar device provided on a home network, or via communications network 1014. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 1016 to access content. Specifically, within a home, users of user television equipment 1002 and user computer equipment 1004 may access the media guidance application to navigate among and locate desirable content. Users may also access the media guidance application outside of the home using wireless user communications devices 1006 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 1014. These cloud resources may include one or more content sources 1016 and one or more media guidance data sources 1018. In addition or in the alternative, the remote computing sites may include other user equipment devices, such as user television equipment 1002, user computer equipment 1004, and wireless user communications device 1006. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 1004 or wireless user communications device 1006 having content capture feature. Alternatively, the user can first transfer the content to a user equipment device, such as user computer equipment 1004. The user equipment device storing the content uploads the content to the cloud using a data transmission service on communications network 1014. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications or the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or, a user device can download content from multiple cloud resources for more efficient downloading. In some embodiments, user equipment devices can use cloud resources for processing operations such as the processing operations performed by processing circuitry described in relation to FIG. 9.

FIG. 11 is an illustrative flow diagram 1100 for presenting a hyper-dimensional media guidance application that may be performed by control circuitry 904 in accordance with some embodiments of the invention. At step 1102, control circuitry 904 may receive a user request from user input interface 910 to access a media guidance application. A user may submit such a request by selecting a selectable option provided in a display screen (e.g., a menu option, a listings option, an icon, a hyperlink, etc.) or by pressing a dedicated button (e.g., a GUIDE button) on a remote control or other user input interface 910.

At step 1104, in response to receiving the user request to access a media guidance application, control circuitry 904 may retrieve from storage 908 content listings to be organized in a content listing grid having default row and column dimensions, such as, for example, time and channel. Control circuitry 904 may also retrieve from storage 908 two next-dimension indicators that are to be displayed on the content listings grid. Next-dimension indicators may be retrieved from, for example, a list of indicators stored in storage 908 or from media guidance source 1018. Control circuitry 904 may generate and transmit to display 912 a grid of content listings and next-dimension indicators displayed on a three-dimensional object as shown in, for example, FIGS. 2A-C and 3. The default row and column indicators and list of next-dimension indicators may be determined from guidance application data received by control circuitry 904.

At step 1106, control circuitry 904 determines whether a user request to specify row and column dimension criteria, to be used in a content listing grid display, has been received from input device 910. A user may submit such a request by selecting a selectable option provided in a display screen (e.g., a menu option, a listings option, an icon, a hyperlink, etc.) or pressing a dedicated button (e.g., a GRID CRITERIA button) on a remote control or other user input interface or device.

At step 1108, in response to receiving a request from a user to specify row and dimension criteria, control circuitry 904 may generate and transmit to display 912 a display screen, such as, for example, display screen 800 as shown in FIG. 8.

At step 1110, control circuitry 904 may determine whether grid criteria entered into display screen 800 has been received. If grid criteria has not been received within a predetermined time period, or control circuitry receives an indication that the user wishes to return to the previous display screen (by actuating a selectable return button or icon, for example), process 1100 may return to step 1104, where control circuitry 904 re-generates the previously displayed content listing display. In response to receiving grid criteria from screen 800, process 1100 may proceed to step 1114, described below.

Returning to step 1106, if control circuitry 904 has determined that no request for specifying row and column dimension criteria has been received, process 1100 may proceed to step 1112.

At step 1112, control circuitry 904 may determine whether a user request to navigate to a new grid with a new row or column dimension has been received from user input interface 910. A user may submit such a request by selecting a navigational icon, such as, for example, navigational icons 220U, 220R, 220L, and 220D of FIGS. 2A-C.

At step 1114, in response to receiving the user request to navigate to another content listings grid, control circuitry 904 may determine the row and column grid dimensions of the requested grid. For example, referring to FIG. 2A, in response to receiving a user navigational actuation of icon 220R, control circuitry 904 may determine that the next row dimension is “time” and the next column dimension is “ratings” (see right side face 234). Control circuitry 904 may then query storage or a database for content listings that correspond to the time and ratings dimensions. In response, control circuitry 904 may retrieve content listings tagged as corresponding to the time and ratings dimensions. Control circuitry 904 may then determine grid cell locations of the content listings based on their tagged dimension information. Control circuitry 904 may further determine the next-dimension indicators that are to be displayed on the requested content listings grid. Control circuitry 904 may retrieve this information from storage 910.

At step 1116, control circuitry 904 may generate and transmit to display 912 an animated display of (1) the three-dimensional object rotating in the direction indicated by the received navigational actuation, and (2) various grid cells receding and emerging into a depth of the three-dimensional object as the object rotates, as shown and described in connection with FIG. 4. Alternatively or additionally, various grid cells may be shown falling off of or flying into their respective grids as the three-dimensional object rotates, as also shown and described in connection with FIG. 4. Control circuitry 904 may also generate and transmit to display 912 a display of a new grid of content listing cells and next-dimension indicators on a newly presented face of the three-dimensional object. Process 1100 may then return to step 1106, unless control circuitry 904 receives a user indication to exit the guidance application.

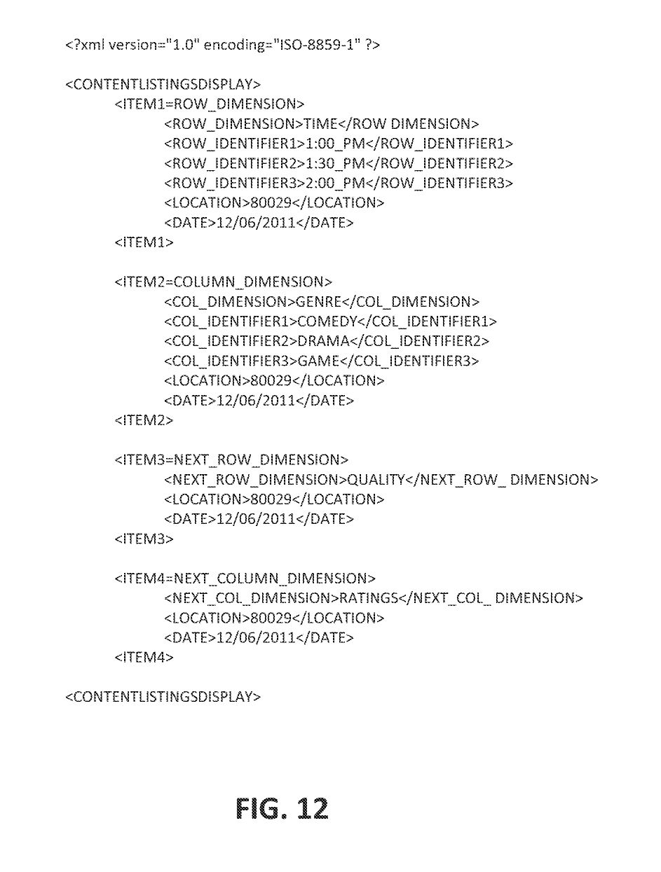

Any suitable mechanism for retrieving content listing grids to be displayed on a three-dimensional object to be presented in a guidance display may be used. For example, in some embodiments, control circuitry 904 may transmit a query to storage or a database for a three-dimensional object, row and column dimensions and ranges, next row and column indicators, and content listings of a particular type (e.g., content listings corresponding to particular row and column dimensions). A response to this query may be received in any suitable format. For example, in some embodiments, a response may be received in an XML structure as illustrated in FIG. 12. In response to receiving the requested data (e.g., row and column dimensions, ranges, and next row and column indicators), control circuitry 904 may determine which content listings correspond to the particular ranges of the row and column dimensions for presentation in the guidance display. This may be based on, for example, a user submitting a request to view a guidance display via input display screen 800, or by the user actuating one of navigational icons 220U, 220R, 220L, and 220D. In response to receiving that request, control circuitry 904 may determine which grid cells of the guidance display are to be filled with the subset of content listings that are to be displayed on a face of the three-dimensional object. Control circuitry 904 may then generate and transmit to display 912 a display of a grid with cells (containing the determined subset of content listings) on a face of the three-dimensional object as indicated in the response to the transmitted query.

It should be understood that the above steps of the flow diagram of FIG. 11 may be executed or performed in any order or sequence not limited to the order and sequence shown and described in the figure. Also, some of the above steps of the flow diagram of FIG. 11 may be executed or performed substantially simultaneously where appropriate or in parallel to reduce latency and processing times.

It should be noted that, although the embodiments described herein generally refer to on-demand media assets and non-on-demand media assets, this is merely illustrative. For example, the control circuitry may divide the guidance display to present media guidance application listings between linear programming (e.g., broadcast listings) and non-linear programming (e.g., on-demand listings, recorded media listings, Internet content listings, etc.).

In some embodiments, any suitable computer readable media can be used for storing instructions for performing the processes described herein. For example, in some embodiments, computer readable media can be transitory or non-transitory. For example, non-transitory computer readable media can include media such as magnetic media (such as hard disks, floppy disks, etc.), optical media (such as compact discs, digital video discs, Blu-ray discs, etc.), semiconductor media (such as flash memory, electrically programmable read only memory (EPROM), electrically erasable programmable read only memory (EEPROM), etc.), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

Thus it is seen that systems and methods of navigating a hyper-dimensional media guidance application are provided. One skilled in the art will appreciate that the invention can be practiced by other than the described embodiments, which are presented for purposes of illustration and not of limitation, and the invention is limited only by the following claims.

1. A method of navigating in an interactive media guidance application, the method comprising:
causing to be displayed a first plurality of content listings arranged in a first grid of cells on a first face of an illustrated three-dimensional object, wherein the first plurality of content listings correspond to a first row of identifiers in a first dimension and a first column of identifiers in a second dimension; and
causing to be displayed a second plurality of content listings arranged in a second grid of cells on a second face of the illustrated three-dimensional object, wherein the second plurality of content listings correspond to either: (1) the first row of identifiers in the first dimension and a second column of identifiers in a third dimension different than the second dimension and corresponding to the navigation option; or (2) the first column of identifiers in the second dimension and a second row of identifiers in a fourth dimension different than the first dimension and corresponding to the navigation option.

2. The method of claim 1, wherein each of the first plurality of content listings and the second plurality of content listings comprises at least one of television content listings, book listings, music listings, movie listings, video-on-demand listings, still image listings, video recording listings, and audio recording listings.

3. The method of claim 1, wherein each of the first dimension and the second dimension is a different one of time, genre, actor, television channels, ratings, and quality.

4. The method of claim 1, wherein a user selection of a navigation option displayed on an edge of the illustrated three-dimensional object is made by pressing an up button, a down button, a left button, or a right button.

5. The method of claim 1, further comprising:
receiving a user request specifying the first dimension, a first range of identifiers of the first dimension, the second dimension, and a second range of identifiers of the second dimension; and
selecting the first plurality of content listings based on the first range of identifiers of the first dimension and the second range of identifiers of the second dimension.

6. The method of claim 1, further comprising, in response to receiving a user selection, causing to be displayed a rotation of the illustrated three-dimensional object.

7. The method of claim 6, further comprising causing to be displayed one of the first plurality of content listings as receding from the first face into a depth of the illustrated three-dimensional object as the illustrated three-dimensional object rotates from displaying the first face to displaying the second face.

8. The method of claim 6, further comprising causing to be displayed one of the second plurality of content listings as emerging from a depth of the illustrated three-dimensional object onto the second face as the illustrated three-dimensional object rotates from displaying the first face to displaying the second face.

9. The method of claim 6, wherein the causing to be displayed of the rotation of the illustrated three-dimensional object comprises causing to be displayed the rotation of the illustrated three-dimensional object about a horizontal axis or a vertical axis extending through the three-dimensional object.

10. The method of claim 1, further comprising:
causing to be displayed a navigation option on an edge of the illustrated three-dimensional object;
receiving a user selection of the navigation option, wherein the second plurality of content listings is caused to be displayed in response to receiving the user selection; and
causing to be displayed a second navigation option on a second edge of the illustrated three-dimensional object.

11. A system for navigating in an interactive media guidance application, the system comprising:
storage;
processing circuitry coupled to storage and configured to:
cause to be displayed a first plurality of content listings arranged in a first grid of cells on a first face of an illustrated three-dimensional object, wherein the first plurality of content listings correspond to a first row of identifiers in a first dimension and a first column of identifiers in a second dimension;
cause to be displayed a second plurality of content listings arranged in a second grid of cells on a second face of the illustrated three-dimensional object, wherein the second plurality of content listings correspond to either: (1) the first row of identifiers in the first dimension and a second column of identifiers in a third dimension different than the second dimension and corresponding to the navigation option; or (2) the first column of identifiers in the second dimension and a second row of identifiers in a fourth dimension different than the first dimension and corresponding to the navigation option.

12. The system of claim 11, wherein each of the first plurality of content listings and the second plurality of content listings comprises at least one of television content listings, book listings, music listings, movie listings, video-on-demand listings, still image listings, video recording listings, and audio recording listings.

13. The system of claim 11, wherein each of the first dimension and the second dimension is a different one of time, genre, actor, television channels, ratings, and quality.

14. The system of claim 11, wherein a user selection of a navigation option displayed on an edge of the illustrated three-dimensional object is made by pressing an up button, a down button, a left button, or a right button.

15. The system of claim 11, wherein the processing circuitry is further configured to:
receive a user request specifying the first dimension, a first range of identifiers of the first dimension, the second dimension, and a second range of identifiers of the second dimension; and
select the first plurality of content listings based on the first range of identifiers of the first dimension and the second range of identifiers of the second dimension.

16. The system of claim 11, wherein the processing circuitry is further configured to, in response to receiving a user selection, cause to be displayed a rotation of the illustrated three-dimensional object.

17. The system of claim 16, wherein the processing circuitry is further configured to cause to be displayed one of the first plurality of content listings as receding from the first face into a depth of the illustrated three-dimensional object as the illustrated three-dimensional object rotates from displaying the first face to displaying the second face.

18. The method of claim 16, wherein the processing circuitry is further configured to cause to be displayed one of the second plurality of content listings as emerging from a depth of the illustrated three-dimensional object onto the second face as the illustrated three-dimensional object rotates from displaying the first face to displaying the second face.

19. The method of claim 16, wherein the processing circuitry is further configured to cause to be displayed the rotation of the illustrated three-dimensional object about a horizontal axis or a vertical axis extending through the three-dimensional object.

20. The system of claim 11, wherein the processing circuitry is further configured to:
cause to be displayed a navigation option on an edge of the illustrated three-dimensional object;
receive a user selection of the navigation option, wherein the second plurality of content listings is caused to be displayed in response to receiving the user selection; and
cause to be displayed a second navigation option on a second edge of the illustrated three-dimensional object.

21-30. (canceled)
